(19) United States
(12) Patent Application Publication
(10) Pub. No.: US 2024/0144724 A1
(43) Pub. Date: May 2, 2024

(54) METHOD OF CROWD ABNORMAL BEHAVIOR DETECTION FROM VIDEO USING ARTIFICIAL INTELLIGENCE

(71) Applicant: VIETTEL GROUP, Ha Noi City (VN)

(72) Inventors: Hong Phuc Vu, Quynh Phu District (VN); Thi Hanh Vu, Hai Phong City (VN); Hong Dang Nguyen, Truc Ninh District (VN); Manh Quy Nguyen, Ha Noi City (VN)

(73) Assignee: VIETTEL GROUP, Ha Noi City (VN)

(21) Appl. No.: 18/476,745

(22) Filed: Sep. 28, 2023

(30) Foreign Application Priority Data
Nov. 2, 2022 (VN) 1-2022-07173

(51) Int. Cl. G06V 40/20; G06T 3/40; G06T 5/00; G06T 5/50; G06V 10/44; G06V 20/52

(52) U.S. Cl. CPC G06V 40/20; G06T 3/40; G06T 5/002; G06T 5/50; G06V 10/44; G06V 20/52; G06T 2207/20216

(57) ABSTRACT

This invention proposes a method of crowd abnormal behavior detection from video using artificial intelligence, includes three steps: step 1: Data-preprocessing; step 2: Feature extraction and abnormal prediction using a three-dimensional convolution neural network (3D CNN), step 3: Post-processing and synthesizing information to issue warning.

### TECHNICAL FIELD

The invention relates to method of crowd abnormal behavior detection from video using artificial intelligence. Particularly, the invention is applied on automatic security monitoring via surveillance cameras.

### BACKGROUND

Abnormal behavior of a group of people such as fights, illegal protests, etc., often causes disorder and insecurity and can lead to social unrest. These behaviors affect a lot of people, especially when they occur in densely populated areas, offices or schools, etc. Therefore, the security agencies need to have early detection and prevent these acts to ensure safety and security for the community.

Currently, the detection of abnormal behavior of the crowd can be done through verifying the reports of people who are present where the incident happened or manually observing surveillance cameras. However, both of them have disadvantages. People's reports can be inaccurate. People who are present where an incident happens may be traumatized or scared, and they may not be able to provide accurate or complete information about what happened. Additionally, people may have different biases and interpretations of what constitutes abnormal behavior, which can lead to false positives or false negatives. So the information reported may take time to be verified. The use of surveillance cameras can overcome the error of using human reports. But it requires constant monitoring of the screen displaying the images from the cameras. However, with a large amount of video data to be viewed daily and multiple cameras in use at the same time, there is a high risk that supervisors will miss out on unusual behavior, especially if they are not paying attention or if they are distracted. In addition, because these behaviors happen infrequently, asking for someone to be on duty at all times or to increase supervisory personnel will cause great waste. Therefore, this invention introduces a method of using artificial intelligence technology to proactively detect the abnormal behavior of the crowd via surveillance camera to automatically warn supervisors. This method helps to reduce the cost of permanent staff, while ensuring high accuracy and timely warning.

### SUMMARY

The purpose of this invention is to propose a method to automatically detect anomalous behaviors of the crowd from video, which can be integrated in security monitoring systems using surveillance cameras.

To achieve this purpose, our method includes three steps:
Step 1: Data pre-processing. The intent of this step is to process raw data to clean and formatted data that is suitable as input of the deep learning model in step 2. Raw data is video streamed from cameras. It is cut to short clips, then short clips are brought back to the same playback rate, sampled, resized and normalized.
Step 2: Feature extraction and abnormal prediction. A three-dimensional convolution neural network (3D CNN) is used to extract spatial-temporal features from pre-processed short clips from step 1. This network then calculates the probability of having anomalous behaviors in each short clip and forwards them to step 3.
Step 3: Post-processing and synthesizing information to issue warnings. This step integrates information from step 2 and removes noise to accurately predict whether or not abnormal behavior will occur.

### BRIEF DESCRIPTION OF THE DRAWINGS

FIG. 1: our proposed method to detect abnormal behaviors of the crowd from video, which contain three steps.

FIG. 2: illustrated step 3—post-processing and integrated information. It will warn if abnormal behaviors are recognized.

### DETAILED DESCRIPTION

The invention detailed below is based on accompanying drawings, which are intended to illustrate variations of the present invention without limiting the scope of the patent.

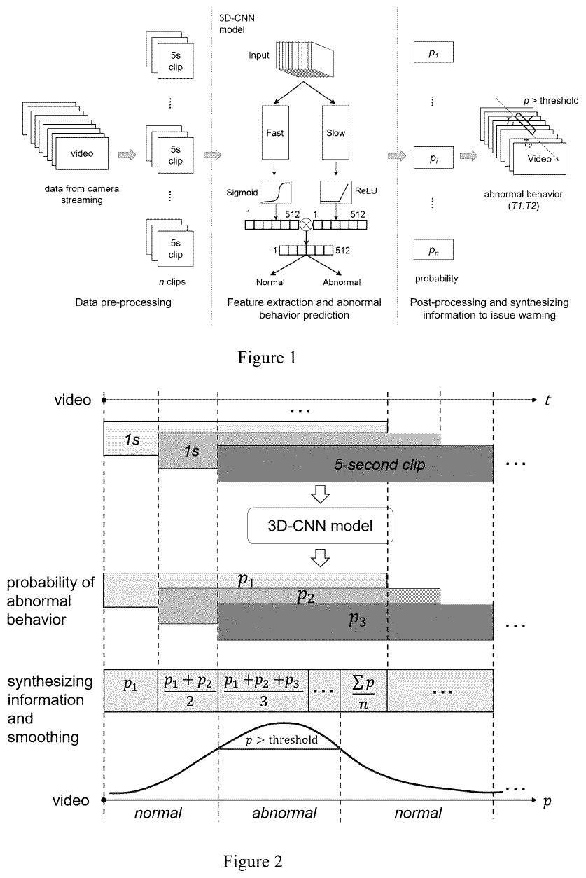

Specifically, the steps of the method mentioned in the present invention are carried out as follows (refer to FIG. 1):

Step 1: Data Pre-Processing

This step aims to process raw data to clean and formatted data that is suitable as input of the deep learning model in step 2. Raw data is video information continuously transmitted from security surveillance cameras (a.k.a. Real Time Streaming Protocol (RTSP)). The input to the deep learning model in step 2 are short clips, so it is necessary to cut the input video into short clips of length 5 seconds, with a sliding window stride on the original video of 1 second (i.e., every 1 second in a row, extract a short clip of length 5 seconds). At the same time, all videos are brought back to the same playback rate of 25 frames per second (FPS). This means the short clips cut out are 125 frames long, the starting point of two consecutive segments is 25 frames apart. Video streams from surveillance cameras are usually large in size (HD, Full HD, 2K video, etc.). To reduce cost and speed up computation and reduce storage memory, this step performs sampling and resizing of frames. 64 frames are sampled from 125 frames with the probability following uniform distribution. Lastly, the frames are resized to 224×224 pixels and normalized to the normal distribution N(0, 1) to become the input of the deep learning model in step 2.

Step 2: Feature Extraction and Abnormal Prediction

This step takes as input the sequence of frames preprocessed in step 1. Each sequence of frames corresponds to a short clip. These frames are then passed through a three-dimensional convolutional neural network (3D CNN) to extract spatial-temporal features and calculate the probability of abnormal behavior in each short clip.

In fact, some simple human actions can be recognized through a single image. The problem of action recognition in a single image can be handled by the two-dimensional convolutional neural networks (2D CNN), which focus on extracting spatial features. However, the behaviors considered in this invention are the behavior of crowds, which contain complex actions and contexts. To accurately predict, it is required a spatial-temporal solution. More specifically, it is necessary to analyze a sequence of consecutive frames to extract important information on both the spatial features, i.e. the objects in each frame, and the temporal features, i.e. the object's actions over consecutive frames. 3D CNN architectures can solve this problem by adding a third convolutional dimension that captures the temporal information.

The proposed model used in this invention is a variant of the SlowFast model. This is a deep learning network built with the purpose of feature extraction and action recognition. This network consists of two branches operating in parallel, the Slow branch for semantic feature extraction (usually slowly changing) and the Fast branch used for motion feature extraction (usually fast changing from frame to frame) in the video. Because the semantic information is usually less variable, the Slow branch only receives input of 4 frames out of 64 frames from the output of step 1, i.e. the stride of 16 frames. In contrast, to capture rapidly changing motion, the Fast branch takes as input 32 of the 64 frames mentioned above. The network architecture of these two branches is similar but differs in the number of convolutional filters. In order to reduce the computational speed and ensure that the Fast branch focuses on extracting motion features instead of spatial features, the number of convolutional filters in this branch is β times smaller than in the Slow branch. (based on experiment, β=8 gives optimal results). The output of each branch is a 512-dimensional vector. In this invention, it is proposed to combine these two output feature vectors by taking their dot product. The result is a single feature vector containing both semantic and motion features. Before taking dot product, a fully-connected layer with the activation function Sigmoid is added after the last layer of the Fast branch, while the corresponding activation function in the Slow branch is Rectified linear unit (ReLU). This is intended to convert the output of the Fast branch into a weight vector. The inner product of this vector and the output vector of the Slow branch produces a feature vector with significant features that have increased influence, while less important features have reduced influence on the classification/prediction results. This improvement helps to increase the classification/prediction efficiency compared to the original SlowFast model.

Next, the final output of the model returns two possible outcomes of video content classification/prediction results: “abnormal behavior” (e.g., violence, protests, etc.) or “normal”, based on the probabilities calculated by the model. Based on research and actual experiments, the model works well when trained with the following set of hyper-parameters: the number of training loops (epochs) is 100, the training batch size is 8, the loss function is Cross-Entropy optimized by the Stochastic Gradient Descent (SGD) optimization algorithm with parameters: the initial learning rate is 5×10⁻⁴. The learning rate gradually decreases during training: if the value of the loss function measured on the optimal data set (validation) does not decrease after a certain number of epochs, the learning rate is reduced by 10 times, and the minimum value is 10⁻⁸. The regularization factor for the loss function is L2 norm, which the weight of 5×10⁻³.

Step 3: Post-Processing and Synthesizing Information to Issue Warnings;

This step aggregates the prediction results on each of the 5-second short clips in step 2 and gives an alert about unusual crowd behavior if any (refer to FIG. 2). Specifically, information is aggregated frame by frame. The probability of anomalous behaviors at a frame is the average of the probability of an anomaly at all 5-second clips containing that frame. This probability is then further smoothed by averaging the 5 frames adjacent to the current frame. In more detail, the probability of crowd abnormality occurring at the T^{th} frame is recalculated as the average of the probabilities at frames T−2, T−1, T, T+1, T+2. This smoothing reduces the effect of noisy information and reduces the impact if the model predicts several frames incorrectly.

Finally, if the measure of the crowd at a frame is greater than a certain threshold (based on related research and our experiments, the threshold p>0.5 for optimal result), the frame of the image is marked as containing abnormal behavior. If the sequence of consecutive frames containing an anomaly is longer than 125 frames (corresponding to a 5-second clip and a 25 FPS playback rate), the system will issue a warning.

Although the above descriptions contain many specifics, they are not intended to be limited to the embodiment of the invention, but are intended only to illustrate some preferred execution options.

We claim:

1. Method of crowd abnormal behavior detection from video using artificial intelligence, comprising three steps:
Step 1: data pre-processing;
raw data streamed from cameras is cut to short clips, the short clips are brought back to a same playback rate, sampled, resized and normalized to produce pre-processed short clips;
Step 2: feature extraction and abnormal prediction;
a three-dimensional convolution neural network (3D CNN) is used to extract spatial-temporal features from the pre-processed short clips from step 1, the 3D-CNN then calculates a probability of having anomalous behaviors in each pre-processed short clip and forwards them to step 3;
Step 3: post-processing and synthesizing information to issue warning; this step integrates information from step 2 and removes noise to accurately predict whether or not abnormal behavior will occur, and issues a warning if any abnormal behavior is predicted to occur.

2. The method of crowd abnormal behavior detection from video using artificial intelligence according to claim 1, in which:
in step 1, the raw data is processed to clean and formatted data that is suitable as input of the 3D CNN in step 2, raw data is video information continuously transmitted from security surveillance cameras (a.k.a. Real Time Streaming Protocol (RTSP)), the input to the 3D CNN in step 2 are short clips, so the input video is cut into short clips of length 5 seconds, with a sliding window stride on the original video of 1 second (i.e., every 1 second in a row, extract a short clip of length 5 seconds), at the same time, all videos are brought back to a same playback rate of 25 frames per second (FPS), this means the short clips cut out are 125 frames long, a starting point of two consecutive segments is 25 frames apart, video streams from surveillance cameras are usually large in size, to reduce cost and speed up computation and reduce storage memory, this step performs sampling and resizing of frames, wherein 64 frames are sampled from 125 frames with a probability following uniform distribution, lastly, the frames are resized to 224×224 pixels and normalized to a normal distribution N(0, 1) to become the input of the deep learning model in step 2.

3. The method of crowd abnormal behavior detection from video using artificial intelligence according to claim 1, in which:
in step 2, the proposed model used in this invention is a variant of a SlowFast model, the output of each Slow and Fast branch is a 512-dimensional vector these two output feature vectors are combined by taking their dot product, resulting in a single feature vector containing both semantic and motion features, before taking dot product, a fully-connected layer with an activation function Sigmoid is added after the last layer of the Fast branch, while the corresponding activation function in the Slow branch is Rectified linear unit (ReLU), to convert the output of the Fast branch into a weight vector, the inner product of this vector and the output vector of the Slow branch produces a feature vector with significant features that have increased influence, while less important features have reduced influence on the classification/prediction results, helping to increase the classification/prediction efficiency compared to the original SlowFast model.

4. The method of crowd abnormal behavior detection from video using artificial intelligence according to claim 1, in which:
in step 3, information is aggregated frame by frame, the probability of anomalous behaviors at a frame is the average of the probability of an anomaly at all 5-second clips containing that frame, this probability is then further smoothed by averaging the 5 frames adjacent to the current frame, that is, the probability of crowd abnormality occurring at the T^{th} frame is recalculated as the average of the probabilities at frames T−2, T−1, T, T+1, T+2, this smoothing reduces the effect of noisy information and reduces the impact if the model predicts several frames incorrectly, finally, if the probability of abnormal behavior of the crowd at a frame is greater than a certain threshold, wherein the threshold p>0.5 for optimal result, the frame of the image is marked as containing abnormal behavior, when the sequence of consecutive frames containing an anomaly is longer than 125 frames (corresponding to a 5-second clip and a 25 FPS playback rate), the system will issue a warning.
